(19) United States
(12) Patent Application Publication
(10) Pub. No.: US 2026/0006105 A1
(43) Pub. Date: Jan. 1, 2026

(54) A METHOD OF GENERATING OPTIMIZED TIMINGS FOR OUTBOUND COMMUNICATIONS

(71) Applicant: Synchrony Bank, Stamford, CT (US)

(72) Inventor: Diego Taracena, Stamford, CT (US)

(21) Appl. No.: 19/250,947

(22) Filed: Jun. 26, 2025

Related U.S. Application Data
(60) Provisional application No. 63/665,900, filed on Jun. 28, 2024.

(51) Int. Cl. H04L 67/55; H04L 67/50

(52) U.S. Cl. CPC H04L 67/55; H04L 67/535

(57) ABSTRACT

Methods are described herein for optimizing notifications using a management platform, which may include receiving a set of one or more user devices associated with a server, where the set of one or more user devices includes user devices that have interacted with the server through one or more activities associated with the server. The method may also include simultaneously tracking one or more actions of the set of one or more user devices at one or more data sources, and generating activity data associated with a user device of the set of one or more user devices. The method may also include determining that a threshold amount of data collected over a duration of time has been met, and dynamically predicting an optimized time for a notification for the user device based on the activity data.

### CROSS REFERENCE TO RELATED APPLICATIONS

This application claims the benefit of U.S. Provisional Patent Application No. 63/665,900, filed Jun. 28, 2024, entitled “A METHOD OF GENERATING OPTIMIZED TIMINGS FOR OUTBOUND COMMUNICATIONS,” which is incorporated herein by reference in its entirety for all purposes.

### TECHNICAL FIELD

This disclosure relates generally to optimizing notifications. More specifically, this disclosure relates to generating recommendations for an optimized time to transmit a notification to a user device.

### BACKGROUND

Outbound communications (e.g., notifications) are often necessary to reach user devices of associated users (e.g., customers, consumers, donors, contributors, supporters, etc.) of an institution. The messages may be a part of a marking campaign, service campaign, collection strategy, requests for feedback, important information, any combination thereof, or the like. A typical outbound communication is in the form of a text message, a phone call, or electronic mail (email). Regarding email communications, the most common approach is to batch groups of emails that are sent to user devices at an arbitrary hour of a given day, which results in a low number of opened and clicked (e.g., interacted with by clicking a link, image, etc.) emails. For text messages, unscheduled messages and lack of a structured framework can cause confusion and dissatisfaction among customers. Phone calls can be perceived as inconvenient and disruptive to a customer's daily activities. Additionally, the schedules of customers, users, consumers, and other individuals vary vastly, thus requiring a customized approach to outbound communications to improve efficacy, conversion rates, and customer satisfaction.

### SUMMARY

Methods are described herein for optimizing notifications using a management platform, which may include receiving an identification of a set of user devices associated with a server, where user devices of the set of user devices have interacted with the server through one or more activities associated with the server. The method may also include tracking one or more actions of the set of user devices at one or more data sources, and generating activity data associated with a user device of the set of user devices. The activity data may be based on the tracked one or more actions. The method may also include determining that a threshold amount of data collected over a duration of time has been met, and dynamically predicting an optimized time based on the activity data to transmit a notification to the user device. The optimized time may include at least a time period where the user device is most likely to respond to the notification.

Systems are described herein for optimizing notifications using a management platform. The systems may comprise one or more processors and a memory storing instructions that, as a result of being executed by the one or more processors, cause the system to perform any of the aforementioned methods.

Non-transitory computer-readable storage media are described herein that store instructions therein that, as a result of being executed by one or more processors, cause the one or more processors to perform any of the aforementioned methods.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### BRIEF DESCRIPTION OF THE DRAWINGS

To easily identify the discussion of any particular element or act, the most significant digit or digits in a reference number refer to the figure number in which that element is first introduced.

FIG. 1 illustrates an example management platform for optimizing notifications according to some aspects of the present disclosure.

FIG. 2A illustrates an example notification system without incorporating the management platform according to some aspects of the present disclosure.

FIG. 2B illustrates an example notification system with the management platform according to some aspects of the present disclosure.

FIG. 3 illustrates an example output of the management platform according to some aspects of the present disclosure.

FIG. 4 illustrates an example flowchart for implementing the management platform according to some aspects of the present disclosure.

FIG. 5 illustrates an example computing device capable of executing the management platform and any other associated components according to some aspects of the present disclosure.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework through which one or more machine learning algorithms and programmatic logic are implemented to dynamically, and in real-time, process incoming invoices and corresponding claims as these invoices are received to identify one or more conditions for which treatment was provided. Based on these identified one or more conditions, as well as any known historical data corresponding to the claimant, adjudication of the invoices and corresponding claims may be performed.

The present disclosure describes a technology that generates individualized times (e.g., day of week, time, time of day, weekend/weekday, any combination thereof, or the like) for devices associated with an institution to increase the likelihood that a device may receive and/or interact with a notification. Throughout the present disclosure, an “institution” may refer to a company, a corporation, a school, a non-profit/charity organization, an association, a government, a store, a service provider, a facility, a team, a business, a hospital and/or healthcare institution, any combination thereof, or the like. Institutions rely on customer interactions in order to maintain the functionality of the business. Clicks on an email link, responses to a text message, answering a marketing or customer service phone call, making a payment online, any combination thereof, or the like, are all manners in which users may interact with an institution. However, many of these interactions require initiation by the institution. In many cases, the initiations come in the form of notifications (e.g., an email, a text, a phone call, etc.) that are easily ignored by a user and/or user device. The management platform discussed herein may generate times (e.g., days of the week, times of day, a day and a time, etc.) that a user and/or user device are most likely to interact with a notification. Notifications such as text messages, SMS, iMessage, phone calls, e-mails, instant messages (IMs), push notifications, any combination thereof, or the like, may be utilized by an institution to encourage and/or entice a user associated with a user device to interact with and/or perform an action associated with the institution.

The management platform may utilize data received from one or more sources associated with the institution. The data points may be gathered from virtual interactions, phone calls, in-person interactions (e.g., store visits), any combination thereof, or the like. Interactions may include payments made, transactions completed, site visits, clicked links, calls to customer service, “chats” with institutional representatives and/or “chatbots,” making a purchase at a physical location, scanning a QR code at a physical location, speaking to a representative of the institution at a physical location, any combination thereof, or the like. The data may be stored in a database accessible to the management platform.

The management platform may synthesize the data stored in the database for consistency. For example, the management platform may transform one or more elements of data within the database to be in the same format or structure so that the one or more elements of data can be used in conjunction. Data from a first source (e.g., a store visit) may be in a different format than data from a second source (e.g., an online payment) and may be transformed and updated within the database for use by the management platform. The management platform may also identify an activity associated with the data and associate the data with an activity tag. The activity tags used within the data may be customized to the particular institution according to activities associated with the institution. For example, activity tags associated with a store visit may be “in-store purchase,” “help desk,” “in-store return,” “in-store exchange,” and/or “in-store visit.” A generic activity (e.g., store visit, website visit, link click, payment, etc.) that may be originally associated with the data stored within the database may be associated with one or more activity tags that further specify the generic activity (e.g., “in-store purchase,” “online shopping,” “email link,” “chatbot,” etc.).

The activity tags associated with an activity and/or data within the database are utilized to determine an impact or weight that a particular activity may have on the output of the management platform. For example, a purchase made on a website associated with the institution may be weighed higher than an interaction with an email. Similarly, a phone call to customer service associated with the institution may be weighted higher than listening to a voice mail from a representative of the institution. The weights associated with an activity or an activity tag may be customized according to the particular institution and/or notification type. For example, a purchase made on a website may impact the calculation for optimized email communications more heavily than the calculation for optimized phone call communications.

The weighted data is analyzed through one or more prediction algorithms to generate recommendations for notification timings. The management platform may identify time periods that the user device is most likely to interact with a particular type of notification. For example, a user may be more likely to read an email sent at 10:00 am on a Monday than at 9:00 pm on a Thursday. As another example, a user may be more likely to answer a phone call at 6:00 pm on a Tuesday than at 11:00 am on a Saturday. In some examples, the management platform may identify a combination of a time and a day, a single time, and/or a single day for one or more user devices. The single time may be the best time on any day for a user device to receive a particular notification. The single day may be the best day at any time for a user device to receive a particular notification. The combination of a time and a day may differ from the single time and/or the single day. For example, the optimized time for a user device to receive a marketing text message may be 9:00 am on Tuesdays, but the single time may be 3:00 pm and the single day may be Fridays.

The management platform may generate this optimization data for one or more user devices associated with the institution. This may be user devices that have made a purchase on a particular website, visitors to a particular storefront, user devices that have made a payment on a website, user devices that have signed up for email marketing communications, users that have attended an event, any combination thereof, or the like. For example, a marketing department and/or program associated with the institution may receive optimization data for one or more user devices associated with the institution and may schedule and/or transmit notifications accordingly. By optimizing communications made to the one or more user devices, institutions may increase sales, visibility, donations, interactions, on-time payments, interest, or any other preferred activity associated with the institution by increasing the likelihood that a user device may receive and acknowledge a notification associated with the institution (e.g., answering a phone call instead of declining, reading/clicking a link in an email instead of deleting it, responding to a text message instead of ignoring the text message, etc.).

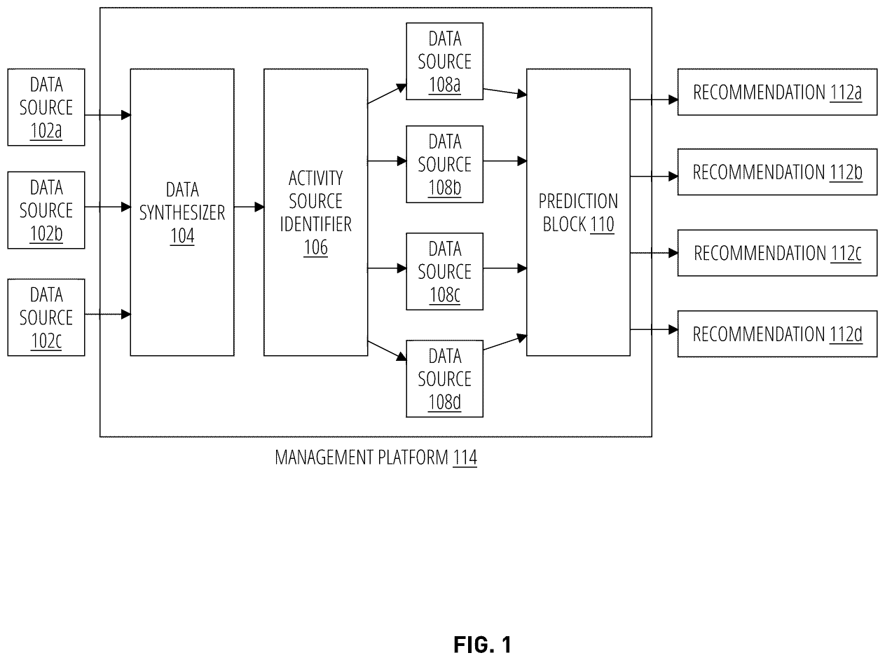

FIG. 1 illustrates an example management platform for optimizing notifications according to some aspects of the present disclosure. Institutions such as businesses, nonprofits, and service providers rely on customer interactions in order to maintain the functionality of the business. Management platform 114 combines a multitude of information sources, observes at which hours of the day user devices are active or inactive, to analyze, summarize, and quantitively simplify a final output that is used by institutional units (e.g., marketing, collections, servicing, etc.) to optimize the times they send an email, an SMS text, or call a customer. Management platform 114 may include components such as, but not limited to, data synthesizer 104, activity source identifier 106, and prediction block 110. All components discussed herein may alone or combination optimize notifications and recommend certain times to transmit a type of notification.

Management platform 114 may be located on a system that may include processing hardware (e.g., one or more processors such as CPU, memory, input components, output components, etc.) and a processor. The processor may include hardware components (e.g., media processor, other processors, memory, etc.) and/or software processes that execute to provide the functionality of management platform 114. In some examples, management platform 114 may be hosted at a central server on a network and one or more institutions may be connected to the network and utilize management platform 114. In some other examples, management platform 114 may be hosted on a server, processor, and/or a device associated with the institution, and may be accessed locally by a processor associated with the institution.

Initially, management platform 114 receives data from data source 102a, data source 102b, and/or data source 102c. The data may be associated with one or more user devices and may be indicative of one or more activities of the one or more user devices. Management platform 114 may transform the data to increase the usability of the data (e.g., adding activity tags/sub-activities, formatting into a database, normalizing the data, etc.) and generate one or more recommendations associated with the one or more user devices. The one or more recommendations may include days, times, or a combination of days and times when a user may be most likely to interact with a particular notification (e.g., text, email, phone call, etc.). These recommendations may be used by marketing teams, departments, notification services, customer service centers, any combination thereof, or the like, to increase visibility and interactions with a user and/or user device. This can lead to higher profitability, higher customer satisfaction, and a higher share of the market.

Data source 102a, data source 102b, and data source 102c (collectively, data source 102) may be data received from one or more activities (e.g., data source 102a may be associated with transactions, data source 102b may be associated with customer service, data source 102c may be associated with in-store activities, etc.) associated with the institution. Data source 102 may transmit data to a server associated with the institution and may include information including, but not limited to, an activity (e.g., a transaction, a store visit, an interaction, etc.), a time (e.g., a day of the week, a time of day, a time, etc.), a sub-activity (e.g., a purchase, a return, an in-store purchase, an email interaction, etc.), an associated user device, an associated user account, a time stamp (e.g., a day, time of day, time, day of week, etc.), any combination thereof, or the like. The activities and sub-activities may be defined by a management platform manager from the institution. The management platform manager may manually define the type of data to be included by data source 102, the activities included in data source 102, the sub-activities included in data source 102, any combination thereof, or the like. Data source 102 may be gathered from one or more sources, including, but not limited to, a storefront, a website, an online chatbot, a phone call, a text message exchange, an interaction on social media, interaction with an email, an online purchase, an online payment, contacts with customer service, any combination thereof, or the like. The one or more activities may be tracked by a server associated with the institution and stored in a database. The database may include large quantities of data associated with a large amount of user devices over a period of time.

Data source 102 may, in some examples, be data gathered from an in-person experience. For example, data source 102 may be from an in-store purchase, attendance at an event associated with an institution, interaction with an in-person advertisement, any combination thereof, or the like. Data source 102 may indicate an in-person experience through wireless communications (e.g., radio frequency, NFC chips, Bluetooth, WiFi connectivity, etc.), an RSVP to an event, purchase data from in in-person payment processing system, record of an in-person interaction with a customer service representative, any combination thereof, or the like.

In some examples, data source 102 may be associated with a type of activity that may be separated into multiple sub-activities. For example, data source 102a may be associated with “transactions,” which may include purchases, returns, and refunds. Data source 102 may transmit data pertaining to multiple user devices or may transmit particular data associated with one user device, depending on the setup of management platform. For example, data source 102a may be associated with “transactions” occurring on a particular website from any user device, while data source 102b may be associated with activities conducted by a single user device (e.g., calling customer service, initiating a return, receiving a return label, interacting with an online chatbot, etc.).

Data source 102 may be gathered via one or more sources, such as software programs, servers, controllers, routers, networking components, Internet tracking (e.g., cookies), any combination thereof, or the like. The one or more sources may be configured to gather data according to a framework from management platform 114. The framework may include when to gather data (e.g., at the occurrence of a particular event, after a certain time period, etc.), what data to include (e.g., time stamps, the type of activity, the duration of the interaction, etc.), how to transmit data (e.g., transmit data to management platform 114 in real-time, every 24 hours, once a calendar week, etc.), any combination thereof, or the like. The central server may facilitate management platform 114 and may transmit these framework instructions to the one or more sources for implementation. In some examples, the central server may be connected to the one or more sources at a central network (e.g., an enterprise network, a wireless network, via the Internet, any combination thereof, or the like). The central network may facilitate communications between the central server and the one or more sources. In some other examples, the framework may be customized according to the institution at a locally-hosted instance of management platform 114. The framework may be generated by an administrator of the institution and/or the locally-hosted instance of management platform 114, or, in some examples, a standard framework within management platform 114.

Management platform 114 may receive the data from data source 102 and may consolidate the data using data synthesizer 104. Data synthesizer 104 may transform and manipulate data source 102 to increase the usability of data source 102. For example, data synthesizer 104 may transform the data into a particular format, normalize the data, adjust the data according to an established standard (e.g., a 24-hour time format, a time zone, etc.), any combination thereof, or the like. In some examples, data synthesizer 104 may also identify one or more user devices associated with a particular activity and/or event within the data received from data source 102. For example, User Device A may be associated with a transaction and an in-store activity included within the data received from data source 102. Data synthesizer 104 may input the transformed data into a database accessible by management platform 114, including, but not limited to, local memory, cloud storage, external memory, any combination thereof, or the like. The database may be a custom database formatted to accommodate data to be used by management platform 114. For example, the database may be formatted as a table, thereby enabling a user device (or a user, user account, user identifier, etc.) to be associated with one or more activities. In some examples, the database may be formatted as a table, but may enable a particular activity (e.g., a transaction, an interaction, etc.) to be associated with a time and a user device. The format of the database may be dependent on the institution, the types of data sources included in data source 102, etc.

The database may identify and sort data from data source 102 in association with one or more user devices. In some examples, the database may be associated with a custom application programming interface (API) to receive the data from the one or more sources. Additionally, the database may utilize a custom graphical user interface (GUI) to display the data within the database using one or more charts generated by management platform 114. For example, the custom GUI may display bar charts, line graphs, scatter plots, histograms, tables, any combination thereof, or the like, that may demonstrate the contents of the vast amounts of data contained within the database.

Activity source identifier 106 may analyze the data transformed by data synthesizer 104 and may evaluate the data for one or more sub-activities. For example, activity source identifier 106 may determine that a set of data associated with a “transaction” may be a purchase made online. Activity source identifier 106 may modify the data stored within the database to include additional information, including a sub-activity. For example, two sets of data associated with “in-store visit” may be further associated with “in-store purchase” and “in-store help desk,” respectively. Activity source identifier 106 may cross-reference the data stored within the database with one or more additional data sources, including call logs, messaging history (e.g., text messaging, email, etc.), in-store records (e.g., help desk records, tracked interactions with store associates, in-store beacons tracking device movement, returns, purchases, etc.), tracking (e.g., GPS on a cell phone) data, bank records, attendance records (e.g., attendance of an online webinar), any combination thereof, or the like.

In some examples, activity source identifier 106 may include a filtering function. The filtering function may limit the data according to a time period (e.g., analyzing data between 8:00 am and 9:00 pm) designated by an administrator of management platform 114. In some examples, the time period may be based on associated regulations, preferences for recommendations (e.g., limiting recommendations/results to “working hours” of 8:00 am to 5:00 pm), any combination thereof, or the like. In some examples, the data may be associated with a geographic location and/or time zone (e.g., Eastern Time Zone, Central Time Zone, Arizona, California, etc.), which may be used to normalize the filtering.

Data source 108a, data source 108b, data source 108c, and data source 108d (collectively, data source 108) may include similar data as data source 102. In some examples, data source 108 may include additional information than is included in data source 102. For example, data source 108 may include sub-activities associated with each activity identified within data source 102. In some other examples, data source 108a, 108b, 108c, and 108d may be formatted in a standard format (e.g., via data synthesizer 104), while data source 102a, 102b, and 102c may vary in format. Data source 108 may be derived from more than one data source 102, or data source 102 may be utilized to generate more than one data source 108. For example, data source 108a may include data gathered from data source 102a and data source 102b unified together to generate a complete data source 108a. In another example, data source 102a may contain an abundance of data and data points and may be used to generate data source 108a and data source 108b. In some other examples, a single data source 102 may correspond to a single data source 108 (e.g., data source 108a is a transformed version of data source 102a).

Prediction block 110 may receive data source 108 and may use data source 108 to generate one or more recommendations that are associated with one or more user devices. Prediction block 110, using one or more mathematical algorithms, may analyze the information included in data source 108. The analysis performed by prediction block 110 may be output as predictions and/or inferences regarding one or more user devices, user accounts, and/or users regarding activities associated with the institution. For example, recommendation 112a may include one or more times that a user device is most likely to interact with an email communication from the institution.

Prediction block 110 may generate the recommendation based on data source 108 using mathematical algorithms, machine-learning algorithms, a weighting framework, trends associated with a particular activity, historical data, any combination thereof, or the like. In some examples, a weighting framework may be generated by an administrator of management platform 114. The weighting framework may associate a sub-activity and/or activity with a value (e.g., from 0.0 to 1.0, with 0.0 indicating the least amount of impact on the result and 1.0 indicating the most impact on the result) associated with a particular notification method. The value may indicate the importance of a sub-activity and/or activity in determining a recommendation for an optimized time to send a notification. For example, the value may indicate a level of attention span necessary to complete a particular activity (e.g., completing an online purchase may have a higher value than opening an email).

In some examples, the weighting framework may be manually generated by an administrator of management platform 114. The administrator may generate the weighting framework via applicable research, goals of the institution (e.g., higher sales, higher marketing reach, more in-store activity with consumers, etc.), demographics of users associated with user devices (e.g., attention span of younger users may be shorter than older users, younger users may be less likely to interact with a phone call than an older user, limited phone service in some geographic regions, etc.), any combination thereof, or the like. In some other examples, the weighting framework may be custom according to a category associated with the institution (e.g., banking, nonprofit, retail, etc.). The weighting framework may also be integrated in a component of management platform 114 and may be consistent through multiple iterations of management platform 114 associated with a variety of institutions.

In some other examples, the weighting framework may be generated according to a machine-learning model. A machine-learning classifier may be implemented in management platform 114 to enable a machine-learning model to generate the weighting framework. The machine-learning classifier may enable one or more machine-learning models trained to identify patterns in activity data and optimize communication efficacy. For example, a first machine-learning model may receive data source 108 and historical data (e.g., prior iterations of data source 102 and/or data source 108, external data, etc.) and may generate the weighting framework.

Examples of machine-learning models include algorithms such as k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. In some instances, the machine-learning model may be trained using training data received and/or derived from data previously received by management platform 114. In some examples, the first machine-learning model may be trained using training data received and/or derived from one or more recommendations associated with a set of data (e.g., a set of data source 102 and/or a set of data source 108). In some instances, the first machine-learning model may be trained using data sources associated with other institutions (e.g., such as other institutions implementing management platform 114 to optimize notifications).

In some examples, the first machine-learning model may be trained using reinforcement training. For example, the first machine-learning model may initialize a policy, take actions, receive rewards or penalties, and update the policy to prioritize actions that lead to higher cumulative rewards. The first machine-learning model can also be trained using supervised training, supervised training, semi-supervised training, reinforcement training, combinations thereof, or the like. The weighting framework may be stored at a location accessible to the central server. In some examples, the weighting framework may be dynamic, such that the first machine-learning model updates the weighting framework after each iteration of generating the recommendations.

In some examples, the one or more machine-learning models (e.g., the first machine-learning model) may also be implemented in other modules within management platform 114. The one or more machine-learning models may be employed within data synthesizer 104 (e.g., the first machine-learning model normalizes the data from data source 102), activity source identifier 106 (e.g., the first machine-learning model identifies sub-activities associated with the activity data), prediction block 110 (e.g., generating recommendation 112), and/or any other component within management platform 114 or connected to management platform 114.

Prediction block 110 may output one or more recommendations (e.g., recommendation 112a, recommendation 112b, recommendation 112c, and recommendation 112d, collectively, recommendation 112) according to the mathematical algorithms, one or more machine-learning models, the weighting framework, data source 108, any combination thereof, or the like. The recommendations of recommendation 112 may be associated with a user device, a user, a user account, a type of notification (e.g., email, text message, phone call, etc.), any combination thereof, or the like. For example, recommendation 112a may be associated with User A and recommendation 112b may be associated with User B. In some other examples, recommendation 112c may be associated with an optimized time to send a text message to one or more users.

The recommendations of recommendation 112 may be output in one or more formats, including a table, a chart, a graph, text, any combination thereof, or the like. Recommendation 112 may be transmitted and stored in a location accessible to the institution and/or management platform 114. In some examples, the recommendations of recommendation 112 may be a table that includes a user, user device, user identification number, or other form of user identifier, associated with one or more times. The times may be categorized according to a type of notification. For example, there may be one or more optimized email times, one or more optimized phone call times, one or more optimized text message times, any combination thereof, or the like. The one or more times may be a time of day, a time, a day of the week, any combination thereof, or the like. For example, an optimized time for User A to receive an email may be 9:00 am on a Monday, 10:00 am on any day, or Tuesdays generally. An institution may utilize this information to transmit a notification (e.g., an email) to User A to obtain the highest possible efficacy (e.g., measured by an interaction with the notification, clicking on the notification, time spent looking at the notification, reading the notification, deleting or not deleting the notification, prompting an action from the notification, any combination thereof, or the like) according to the institution. The highest possible efficacy may vary from one institution to another institution.

In some examples, recommendation 112 may be displayed via a custom GUI on a user interface of a user device. The custom GUI may display a filtered version of recommendation 112 according to one or more parameters indicated by the user device. For example, recommendation 112 may be filtered based on a geolocation of the user device, a local time associated with the user device (e.g., displaying recommendations of recommendation 112 that are within a 30-minute window of the local time, showing a threshold number of recommendations of recommendation 112 that are subsequent to the local time), a notification type associated with recommendation 112 (e.g., only showing recommendations of recommendation 112 that are associated with e-mail notifications), a subgroup of recommendation 112 that are associated with a particular demographic (e.g., only displaying recommendations of recommendation 112 that are associated with female users), any combination thereof, or the like. The custom GUI may display the filtered version of recommendation 112 as a list, a table, a graph, or any other display method that may demonstrate the filtered version of recommendation 112. The custom GUI improves the efficiency of interpreting recommendation 112 by limiting the displayed data to data that is of interest to a user. This saves the user time by reducing the navigation and manual filtering that is necessary to view pertinent recommendations of recommendation 112.

The recommendations of recommendation 112 may be updated periodically according to one or more settings associated with management platform 114. For example, an administrator associated with the institution may request management platform 114 to updated recommendation 112 every 24 hours, week, month, every 70 days, at a threshold (e.g., after a certain amount of new users and/or user devices that are not associated with prior recommendations are included within data source 102, after a certain amount of notifications are transmitted, etc.), at an event (e.g., at the launch of a new product and/or service, after a large institutional announcement, after the occurrence of a large in-store event, after a major national event, etc.), any combination thereof, or the like. In some examples, management platform 114 may automatically update recommendation 112 after a certain threshold amount of time according to default settings associated with management platform 114. In some other examples, a request to update recommendation 112 may be transmitted from the central server associated with management platform 114, if applicable.

In some examples, a notification module (e.g., a program associated with a marketing department of an institution, an automated email service, an automated text message service, a call center, any combination thereof, or the like) may receive recommendation 112 and adjust the transmission of notifications accordingly. For example, an email notification to a multitude of users may be staggered according to the optimized times associated with each of the multitude of users. The email may be transmitted to User A on Monday at 9:00 am, User B on Tuesday at 8:00 pm, and User C on Saturday at 1:00 pm. In some examples, the notification module may identify trends within recommendation 112 and may transmit a notification accordingly. For example, the notification module may identify that the optimized day of the week to receive a phone call is Tuesday for 47% of devices (e.g., the dominant preference, the primary selection, the majority, etc.) included within recommendation 112. Thus, the notification module may instruction associated call centers to conduct phone surveys on Tuesdays.

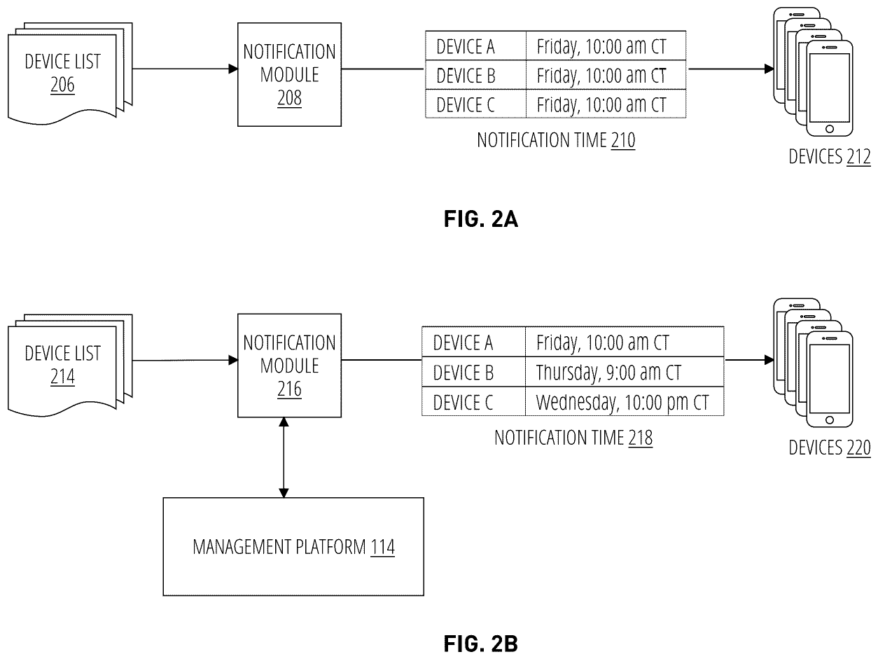

FIG. 2A illustrates an example notification system without incorporating the management platform according to some aspects of the present disclosure. This illustration is for example purposes only and is not intended to limit the contents of this disclosure. Device list 206 may be generated by the institution (e.g., a list of members, subscribers, webpage viewers, followers, any combination thereof, or the like) and may be provided to notification module 208. Device list 206 may be a list of devices or may be a list of users. The users of the list of users may be identified individually by a unique user identifier (ID). Notification module 208 may be associated with a marketing department of the institution, may be a third party tasked with transmitting notifications on behalf of the institution, a server capable of following commands to transmit notifications, any combination thereof, or the like. Notification module 208 may be the module responsible for transmitting notifications of varying types, including, but not limited to, emails, text messages, and phone calls.

Notification module 208 may receive a command from an administrator, a schedule, a central controller, any combination thereof, or the like, and may initiate the transmission of a notification to devices included on device list 206. For example, notification module 208 may transmit an email, a text message, or initiate a phone call with one or more devices (and/or users) according to the command. As shown in notification time 210, the notifications may be transmitted at the same time. This deployment is typical in institutions where a notification is transmitted and/or initiated to one or more devices (e.g., devices 212) at the same time, without taking into consideration the habits of the user associated with each of the one or more user devices.

FIG. 2B illustrates an example notification system with the management platform according to some aspects of the present disclosure. This illustration is for example purposes only and is not intended to limit the contents of this disclosure. FIG. 2B demonstrates one of many possible embodiments and/or examples for utilizing management platform 114 and incorporating it into a notification procedure for an institution. FIG. 2B displays a similar configuration as what is shown in FIG. 2A, however, notification module 216 incorporates management platform 114 prior to transmitting the notifications to devices 220.

Notification module 216 may receive device list 214 and a corresponding notification associated with 214. Device list 214 may be a list of devices or may be a list of users. The users of the list of users may be identified individually by a unique user identifier (ID). As demonstrated by notification time 218, notification module 216 receives recommendations from management platform 114 prior to transmitting the notification and subsequently updates the time of transmission for the notifications according to the recommendations provided by management platform 114. This is in contrast to what is shown in FIG. 2A, with notification time 210 including the same times for all user devices. Notification time 218 shows varying times, generated according to recommendations from management platform 114. Notification module 216 may transmit a notification (e.g., an email, a text message, a phone call) to a device and/or a user according to the recommendations provided by management platform 114 (e.g., as shown in notification time 218).

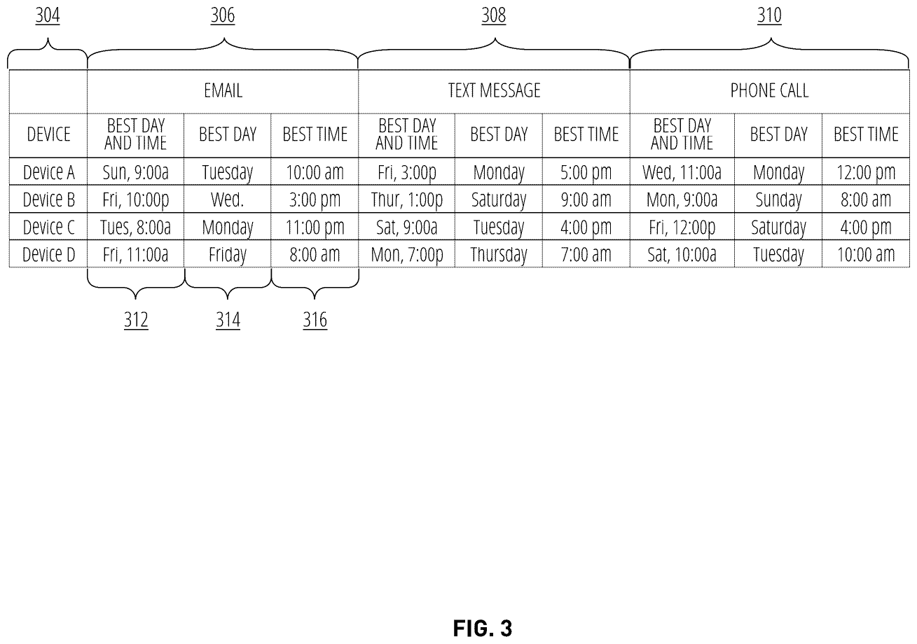

FIG. 3 illustrates an example output of the management platform according to some aspects of the present disclosure. This illustration is for example purposes only and is not intended to limit the contents of this disclosure. A table may be a possible method of display for the recommendations generated by the management platform, but the management platform may also use any other type of data organization method to output the recommendations (e.g., a table, a chart, a graph, a database of any structure, code, commands, on a custom GUI, with text, any combination thereof, or the like. In some examples, a visual output may not be necessary, and management platform may directly output the recommendations and/or optimized times to an appropriate mechanism, module, manager, server, controller, computer, any combination thereof, or the like. The management platform may also be directly integrated into a processor intended to manage the transmission of notifications or any other similar actions.

As shown in FIG. 3, recommendations may be displayed in a table. Column 304 shows the names of devices, but, in some examples, column 304 may display another form of identification, such as an email address, an ID number, a name, a username, a group, a MAC address, and IP address, any combination thereof, or the like. For example, the functionality of FIG. 3 may be performed for a user associated with a user ID, in addition to or in lieu of a specific device. Sections 306, 308, and 310 correspond to recommendations for email, text messages, and phone calls, respectively. Each section displays a variety of times, days of week, or a combination thereof, that a device and/or a user associated with a user ID (shown in column 304) is most likely to interact with a notification.

As an example, section 306 (email) includes three additional sub-columns, 312, 314, and 316. These columns display the best day and time, best day, and best time, respectively. The “best day and time” indicates the best possible time for a device to be notified for a particular type of notification. For example, as shown in FIG. 3, the best day and time for Device A to receive an email is Sunday at 9:00 am. The best day for Device A to receive an email may be Tuesdays, generally. This may indicate that of all the days of the week, Device A is most likely to interact with an email on Tuesdays. The best time for Device A to receive an email may be 10:00 am. This may indicate that on any given day of the week, Device A is most likely to interact with an email if it is sent at 10:00 am.

As shown with the example illustrated above, the “best day and time” may not necessarily be the same as the “best day” and/or “best time.” For example, just because the “best day and time” is Friday at 10:00 am, that does not necessarily indicate that the “best day” is Friday and the “best time” is 10:00 am. Due to the weighting factors and algorithms within the management platform, these optimized times may vary from one another.

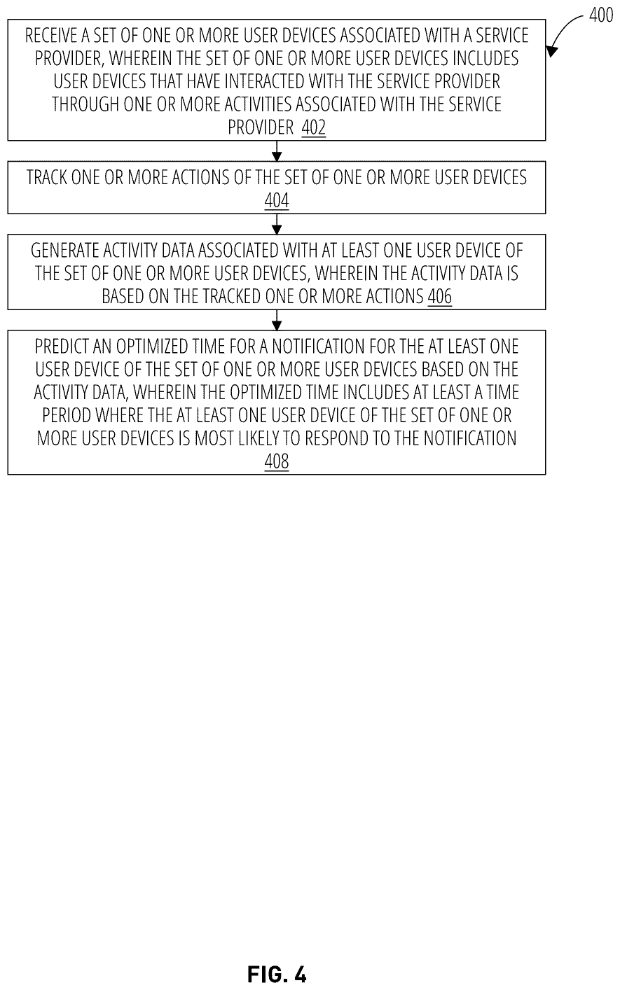

FIG. 4 illustrates an example flowchart for implementing a management platform according to some aspects of the present disclosure. Although the example routine 400 depicts a particular sequence of operations, the sequence may be altered without departing from the scope of the present disclosure. For example, some of the operations depicted may be performed in parallel or in a different sequence that does not materially affect the function of the routine 400. In other examples, different components of an example device or system that implements the routine 400 may perform functions at substantially the same time or in a specific sequence.

According to some examples, the method includes receiving an indication of a set of user devices associated with a service provider, wherein user devices of the set of user devices have interacted with the service provider through one or more activities associated with the service provider at block 402. The one or more activities of the one or more user devices may include a transaction, an in-store activity, communicating with customer service, interacting with a notification (e.g., an email, a link in a text message, answering a phone call, etc.), visiting a website, any combination thereof, or the like.

According to some examples, the method includes tracking one or more actions of the set of user devices at block 404. The one or more actions may be tracked by software programs, servers, controllers, routers, networking components, Internet tracking (e.g., cookies), any combination thereof, or the like.

According to some examples, the method includes generating activity data associated with a user device of the set of user devices, wherein the activity data is based on the tracked one or more actions at block 406. In some examples, the activity data may be normalized according to a framework associated with the management platform. This may include changing the format of the data, interpolating points in the data, arranging the data in a database, any combination thereof, or the like. In some examples, the activity data may be stored in a customized database with a custom data structure associated with the management platform.

In some examples, the management platform may identify, according to the activity data, a sub-action associated with an action of the tracked one or more actions by cross-referencing the activity data with data from one or more additional data sources, including call logs, messaging history (e.g., text messaging, email, etc.), in-store records (e.g., help desk records, tracked interactions with store associates, in-store beacons tracking device movement, returns, purchases, etc.), tracking (e.g., GPS on a cell phone) data, bank records, attendance records (e.g., attendance of an online webinar), any combination thereof, or the like. The sub-action may be stored in associated with respective activity data in the database.

The management platform may weigh the activity data based on a weighting framework based on the sub-activity, a type of notification, any combination thereof, or the like. The weight may be determined by an administrator of the management platform, a central server associated with the management platform, a machine-learning model, any combination thereof, or the like.

According to some examples, the method includes dynamically predicting an optimized time based on the activity data to transmit a notification to the user device, wherein the optimized time includes at least a time period where the at least one user device of the set of one or more user devices is most likely to respond to the notification at block 408. The notification may be an e-mail, SMS, or phone call communication. In some examples, the optimized time is specific to a type of notification. The management platform may then display the optimized time via a customized GUI associated with the service provider.

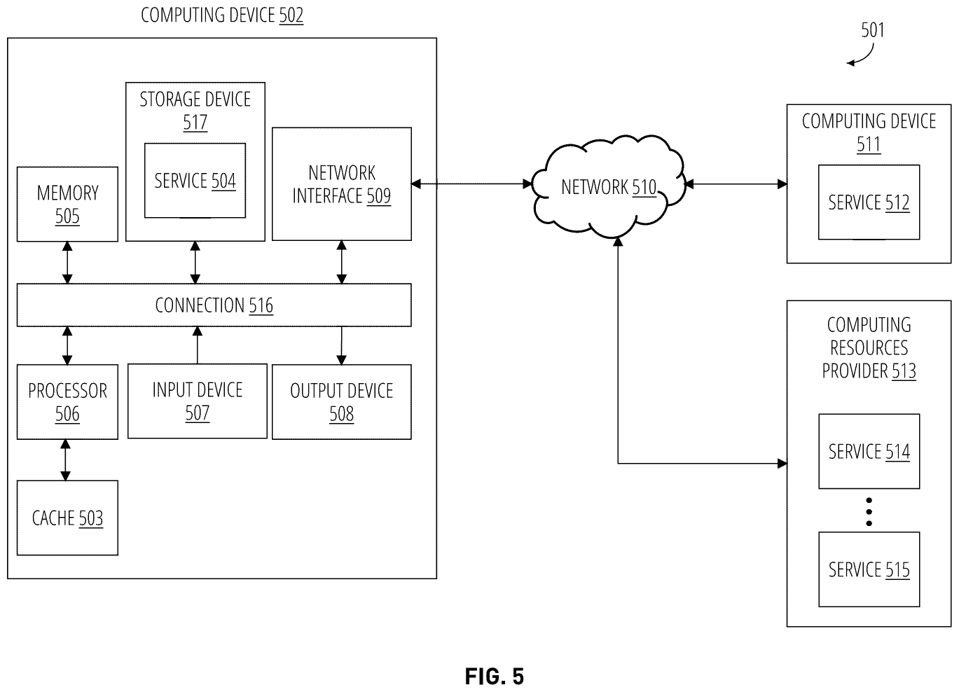

FIG. 5 illustrates an example computing device capable of executing the integrated service and any other associated components according to some aspects of the present disclosure. This may include a computing system architecture 501, including various components in electrical communication with each other. The example computing system architecture 501 illustrated in FIG. 5 includes a computing device 502, which has various components in electrical communication with each other using a connection 516, such as a bus, in accordance with some implementations. The example computing system architecture 501 includes a processor 506 that is in electrical communication with various system components, using the connection 516, and including the system memory 505. In some embodiments, the system memory 505 includes read-only memory (ROM), random-access memory (RAM), and other such memory technologies including, but not limited to, those described herein. In some embodiments, the example computing system architecture 501 includes cache 503 of high-speed memory connected directly with, in close proximity to, or integrated as part of the processor 506. System architecture 501 can copy data from memory 505 and/or the storage device 517 to cache 503 for quick access by processor 506. In this way, cache 503 can provide a performance boost that decreases or eliminates processor delays in processor 506 due to waiting for data. Using modules, methods, and services such as those described herein, processor 506 can be configured to perform various actions. In some embodiments, cache 503 may include multiple types of cache including, for example, level one (L1) and level two (L2) cache. The memory 505 may be referred to herein as system memory or computer system memory. The memory 505 may include, at various times, elements of an operating system, one or more applications, data associated with the operating system or the one or more applications, or other such data associated with the computing device 502.

Other system memory 505 can be available for use as well. The memory 505 can include multiple different types of memory with different performance characteristics. Processor 506 can include any general-purpose processor and one or more hardware or software services, such as service 504 stored in storage device 517, configured to control processor 506 as well as a special-purpose processor where software instructions are incorporated into the actual processor design. Processor 506 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 506 can be a microprocessor, a microcontroller, a digital signal processor (“DSP”), or a combination of these and/or other types of processors. In some embodiments, the processor 506 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 501, an input device 616 can represent any number of input mechanisms, such as a microphone for speech, a touch-sensitive screen for gesture or graphical input, keyboard, mouse, motion input, pen, and other such input devices. An output device 508 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 501. In some embodiments, the input device 507 and/or the output device 508 can be coupled to the computing device 502 using a remote connection device such as, for example, a communication interface such as the network interface 509 described herein. In such embodiments, the communication interface can govern and manage the input and output received from the attached input device 507 and/or output device 508. As may be contemplated, there is no restriction on operating on any particular hardware arrangement and accordingly the basic features here may easily be substituted for other hardware, software, or firmware arrangements as they are developed.

In some embodiments, the storage device 517 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 517 can include hardware and/or software services such as service 504 that can control or configure the processor 506 to perform one or more functions including, but not limited to, the methods, processes, functions, systems, and services described herein in various embodiments. In some embodiments, the hardware or software services can be implemented as modules. As illustrated in example computing system architecture 501, the storage device 517 can be connected to other parts of the computing device 502 using the system connection 516. In some embodiments, a hardware service or hardware module such as service 504, that performs a function can include a software component stored in a non-transitory computer-readable medium that, in connection with the necessary hardware components, such as the processor 506, connection 516, cache 503, storage device 517, memory 505, input device 507, output device 508, and so forth, can carry out the functions such as those described herein.

The disclosed systems and service of the integrated service (e.g., management platform 114 described herein at least in connection with FIG. 1) can be performed using a computing system such as the example computing system illustrated in FIG. 5, using one or more components of the example computing system architecture 100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for facilitating requests using an integrated service (e.g., management platform 114 described herein at least in connection with FIG. 1) described herein by, for example, executing code using a processor such as processor 504 wherein the code is stored in memory such as memory 505 as described herein. One or more of a user device, a provider server or system, a database system, or other such devices, services, or systems may include some or all of the components of the computing system such as the example computing system illustrated in FIG. 5, using one or more components of the example computing system architecture 501 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 513. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

Processor 506 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 505 can be coupled to the processor 506 by, for example, a connector such as connection 516, or a bus. As used herein, a connector or bus such as connection 516 is a communications system that transfers data between components within the computing device 502 and may, in some embodiments, be used to transfer data between computing devices. The connection 516 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 505 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connection 516 (or bus) can also couple the processor 506 to the storage device 517, which may include non-volatile memory or storage, and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 517. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 516 can also couple the processor 506 to a network interface device such as the network interface 509. The interface can include one or more of a modem or other such network interfaces including, but not limited to those described herein. It will be appreciated that the network interface 509 may be considered to be part of the computing device 502 or may be separate from the computing device 502. The network interface 509 can include one or more of an analog modem, Integrated Services Digital Network (ISDN) modem, cable modem, token ring interface, satellite transmission interface, or other interfaces for coupling a computer system to other computer systems. In some embodiments, the network interface 509 can include one or more input and/or output (I/O) devices. The I/O devices can include, by way of example but not limitation, input devices such as input device 507 and/or output devices such as output device 508. For example, the network interface 509 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 511 via a network 510 using a connection such as the network interface 509. In such embodiments, the computing device 511 may execute one or more services 512 to perform one or more functions under the control of, or on behalf of, programs and/or services operating on computing device 502. In some embodiments, a computing device such as computing device 511 may include one or more of the types of components as described in connection with computing device 502 including, but not limited to, a processor such as processor 506, a connection such as connection 516, a cache such as cache 503, a storage device such as storage device 517, memory such as memory 505, an input device such as input device 507, and an output device such as output device 508. In such embodiments, the computing device 511 can carry out the functions such as those described herein in connection with computing device 502. In some embodiments, the computing device 502 can be connected to a plurality of computing devices such as computing device 511, each of which may also be connected to a plurality of computing devices such as computing device 511. Such an embodiment may be referred to herein as a distributed computing environment.

The network 510 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IOT network) or any other such network or combination of networks. Communications via the network 510 can be wired connections, wireless connections, or combinations thereof. Communications via the network 510 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 510, within the computing device 502, within the computing device 511, or within the computing resources provider 513 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by computing device 502 and presented to a user of computing device 502 using forms that are perceptible via sight, sound, smell, taste, touch, or other such mechanisms. In some embodiments, communications over the network 510 can be received and/or processed by a computing device configured as a server. Such communications can be sent and received using PHP: Hypertext Preprocessor (“PHP”), Python™M, Ruby, Perl® and variants, Java®, HTML, XML, or another such server-side processing language.

In some embodiments, the computing device 502 and/or the computing device 511 can be connected to a computing resources provider 513 via the network 510 using a network interface such as those described herein (e.g., network interface 509). In such embodiments, one or more systems (e.g., service 514 and service 515) hosted within the computing resources provider 513 (also referred to herein as within “a computing resources provider environment”) may execute one or more services to perform one or more functions under the control of, or on behalf of, programs and/or services operating on computing device 502 and/or computing device 511. Systems such as service 514 and service 515 may include one or more computing devices such as those described herein to execute computer code to perform the one or more functions under the control of, or on behalf of, programs and/or services operating on computing device 502 and/or computing device 511.

For example, the computing resources provider 513 may provide a service, operating on service 514 to store data for the computing device 502 when, for example, the amount of data that the computing device 502 exceeds the capacity of storage device 517. In another example, the computing resources provider 513 may provide a service to first instantiate a virtual machine (VM) on service 515, use that VM to access the data stored on service 515, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 513 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 513 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 514 and service 515 may implement versions of various services (e.g., service 504 or the service 512) on behalf of, or under the control of, computing device 502 and/or computing device 511. Such implemented versions of various services may involve one or more virtualization techniques so that, for example, it may appear to a user of computing device 502 that the service 504 is executing on the computing device 502 when the service is executing on, for example, service 514. As may also be contemplated, the various services operating within the computing resources provider 513 environment may be distributed among various systems within the environment as well as partially distributed onto computing device 511 and/or computing device 502.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a computer-implemented method for optimizing notifications using a management platform, comprising: receiving an identification of a set of user devices associated with a server, wherein user devices of the set of user devices have interacted with the server through one or more activities associated with the server; tracking one or more actions of the set of user devices at one or more data sources; generating activity data associated with a user device of the set of one or more user devices, wherein the activity data is based on the tracked one or more actions; determining that a threshold amount of data collected over a duration of time has been met; and dynamically predicting an optimized time based on the activity data to transmit a notification for the user device, wherein the optimized time includes at least a time period where the user device is most likely to respond to the notification.

Example 2 is a computer-implemented method for optimizing notifications, comprising: receiving a set of one or more user devices associated with a service provider, wherein the set of one or more user devices includes user devices that have interacted with the service provider through one or more activities associated with the service provider; tracking one or more actions of the set of one or more user devices, wherein multiple of the one or more actions are performed simultaneously; generating activity data associated with at least one user device of the set of one or more user devices, wherein the activity data is based on the tracked one or more actions; and predicting an optimized time for a notification for the at least one user device of the set of one or more user devices based on the activity data, wherein the optimized time includes at least a time period where the at least one user device of the set of one or more user devices is most likely to respond to the notification.

Example 3 is the computer-implemented method of example(s) 1-2, wherein the optimized time is specific to a type of notification.

Example 4 is the computer-implemented method of example(s) 1-3, further comprising: weighting the activity data based on a weighting framework.

Example 5 is the computer-implemented method of example(s) 1-4, further comprising: normalizing data received from the tracked one or more actions; and storing the data in a customized database.

Example 6 is the computer-implemented method of example(s) 1-5, further

comprising: identifying, according to the activity data, a sub-action associated with an action of the tracked one or more actions; and associating the sub-action with activity data based on the action.

Example 7 is the computer-implemented method of example(s) 1-6, further comprising: displaying the optimized time via a customized GUI associated with the service provider.

Example 8 is the computer-implemented method of example(s) 1-7, wherein the notification is an e-mail, SMS, or phone call communication.

Example 9 is a system comprising of one or more processors and a non-transitory computer-readable medium storing instructions that when executed by the one or more processors cause the one or more processors to perform the methods of any of example(s) 1-8.

Example 10 is a non-transitory computer-readable medium storing instructions that when executed by the one or more processors cause the one or more processors to perform the methods of any of example(s) 1-8.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory, or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example method 400 of FIG. 4). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation- maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, meta-learning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computing device 502.

In general, the routines executed to implement the implementations of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method for optimizing notifications using a management platform, comprising:
receiving an identification of a set of user devices associated with a server, wherein user devices of the set of user devices have interacted with the server through one or more activities associated with the server;
tracking one or more actions of the set of user devices at one or more data sources;
generating activity data associated with a user device of the set of user devices, wherein the activity data is based on the tracked one or more actions;
determining that a threshold amount of data collected over a duration of time has been met; and
dynamically predicting an optimized time based on the activity data to transmit a notification to the user device, wherein the optimized time includes at least a time period where the user device is most likely to respond to the notification.

2. The computer-implemented method of claim 1, wherein the notification is an e-mail, SMS, or phone call communication.

3. The computer-implemented method of claim 1, wherein the optimized time is specific to a type of notification.

4. The computer-implemented method of claim 1, further comprising:
weighting the activity data based on a weighting framework.

5. The computer-implemented method of claim 1, further comprising:
normalizing data received from the tracked one or more actions; and
storing the data in a customized database.

6. The computer-implemented method of claim 1, further comprising:
identifying, according to the activity data, a sub-action associated with an action of the tracked one or more actions.

7. The computer-implemented method of claim 1, further comprising:
displaying the optimized time via a customized GUI associated with a service provider.

8. A system comprising:
one or more processors; and
a non-transitory computer-readable medium storing instructions that, when executed by the one or more processors, cause the one or more processors to perform a method comprising:
receiving an identification of a set of user devices associated with a server, wherein user devices of the set of user devices have interacted with the server through one or more activities associated with the server;
tracking one or more actions of the set of user devices at one or more data sources;
generating activity data associated with a user device of the set of user devices, wherein the activity data is based on the tracked one or more actions;
determining that a threshold amount of data collected over a duration of time has been met; and
dynamically predicting an optimized time based on the activity data to transmit a notification to the user device, wherein the optimized time includes at least a time period where the user device is most likely to respond to the notification.

9. The system of claim 8, wherein the notification is an e-mail, SMS, or phone call communication.

10. The system of claim 8, wherein the optimized time is specific to a type of notification.

11. The system of claim 8, wherein the instructions further cause the one or more processors to perform the method comprising:
weighting the activity data based on a weighting framework.

12. The system of claim 8, wherein the instructions further cause the one or more processors to perform the method comprising:
normalizing data received from the tracked one or more actions; and
storing the data in a customized database.

13. The system of claim 8, wherein the instructions further cause the one or more processors to perform the method comprising:
identifying, according to the activity data, a sub-action associated with an action of the tracked one or more actions.

14. The system of claim 8, wherein the instructions further cause the one or more processors to perform the method comprising:
displaying the optimized time via a customized GUI associated with a service provider.

15. A non-transitory computer-readable medium storing instructions that, when executed by one or more processors, cause the one or more processors to perform a method comprising:
receiving an identification of a set of user devices associated with a server, wherein user devices of the set of user devices have interacted with the server through one or more activities associated with the server;
tracking one or more actions of the set of user devices at one or more data sources;
generating activity data associated with a user device of the set of user devices, wherein the activity data is based on the tracked one or more actions;
determining that a threshold amount of data collected over a duration of time has been met; and
dynamically predicting an optimized time based on the activity data to transmit a notification to the user device, wherein the optimized time includes at least a time period where the user device is most likely to respond to the notification.

16. The non-transitory computer-readable medium of claim 15, wherein the notification is an e-mail, SMS, or phone call communication.

17. The non-transitory computer-readable medium of claim 15, wherein the optimized time is specific to a type of notification.

18. The non-transitory computer-readable medium of claim 15, wherein the instructions further cause the one or more processors to perform the method comprising:
weighting the activity data based on a weighting framework.

19. The non-transitory computer-readable medium of claim 15, wherein the instructions further cause the one or more processors to perform the method comprising:
normalizing data received from the tracked one or more actions; and
storing the data in a customized database.

20. The non-transitory computer-readable medium of claim 15, wherein the instructions further cause the one or more processors to perform the method comprising:
identifying, according to the activity data, a sub-action associated with an action of the tracked one or more actions.
